(19) United States
(12) Patent Application Publication
(10) Pub. No.: US 2006/0234658 A1
(43) Pub. Date: Oct. 19, 2006

(54) Mobile communication terminal supporting simultaneous GPS

(76) Inventors: Yoon-min Sue, Seoul (KR); Jae-hyun Lee, Seoul (KR)

Correspondence Address: CANTOR COLBURN, LLP, 55 GRIFFIN ROAD SOUTH, BLOOMFIELD, CT, 06002, US

(21) Appl. No.: 11/258,295

(22) Filed: Oct. 25, 2005

(30) Foreign Application Priority Data
Jan. 4, 2005 (KR) 10-2005-0000540

(51) Int. Cl. H04B 17/02; H04M 1/00

(52) U.S. Cl. 455/133; 455/552.1

(57) ABSTRACT

There is provided a mobile communication terminal supporting S-GPS (Simultaneous Global Positioning System) which has a controller, a keypad, a display unit, an audio processor, a memory unit, and an RF transceiver, the mobile communication terminal including: a wideband antenna which receives a CDMA-band signal, a PCS-band signal, and a GPS-band signal; a GPS antenna which receives only a GPS-band signal; and a switching unit which switches to connect the wideband antenna or the GPS antenna to a GPS receiver according to a control signal so that a GPS signal can be received via the wideband antenna or the GPS antenna.

### BACKGROUND OF THE INVENTION

This application claims the priority of Korean Patent Application No. 2005-00540, filed on Jan. 4, 2005, in the Korean Intellectual Property Office, the disclosure of which is incorporated herein in its entirety by reference.

1. Field of the Invention

The present invention relates to a mobile communication terminal supporting simultaneous global positioning system (S-GPS) and, more particularly, to a mobile communication terminal capable of supporting S-GPS regardless of whether or not the mobile communication terminal is in use.

2. Description of Related Art

A conventional mobile communication terminal equipped with GPS function can support GPS while being in an idle state. However, while being in use, the mobile communication terminal is difficult to provide S-GPS support since there is no in dependent reception path for GPS only. The S-GPS allows simultaneous operation of GPS location capabilities and voice calls.

Recently, a mobile communication terminal having an independent GPS reception path has been released to provide S-GPS support.

The mobile communication terminal supporting S-GPS includes two independent paths, i.e., a radio frequency transmission/reception path (RF Tx/Rx path) for transmitting/receiving voice or data and a GPS Rx path for receiving GPS information, so that voice and data communications can be made through the RF Tx/Rx path and GPS information can be received through the GPS Rx path.

The mobile communication terminal supporting S-GPS can be classified as follows: a mobile communication terminal equipped with a wideband antenna for receiving CDMA (Code Division Multiple Access)-band signal, PCS (Personal Communication Services)-band signal, and GPS-band signal, and a mobile communication terminal equipped with a wideband antenna for receiving CDMA-band signal and PCS-band signal and a GPS antenna for receiving GPS-band signal.

In case of the mobile communication terminal equipped with a wideband antenna only, the mobile communication terminal can provide GPS support in its idle state. However, while it is in use, the mobile communication terminal makes voice or data communication and, at the same time, receives GPS information via a single antenna. As a result, there is a problem in that the mobile communication terminal is difficult to provide GPS support due to ‘Tx to Rx isolation’, which implies that a Tx signal affects a Rx signal.

Meanwhile, in case of the mobile communication terminal equipped with wideband and GPS antennas, the mobile communication terminal can make voice or data communication via the wideband antenna and receive GPS information via the GPS antenna, regardless of whether or not it is in use.

A conventional mobile communication terminal equipped with the wideband antenna and GPS antenna is depicted in FIG. 1.

FIG. 1 is a block diagram of a conventional mobile communication terminal supporting S-GPS, which is a triple-band type mobile communication terminal supporting CDMA/PCS/GPS functions.

The mobile communication terminal includes a controller 110, a keypad 120, a display unit 130, an audio processor 140 processing audio signals inputted or outputted through a microphone or a speaker, a memory unit 150, a CDMA transceiver 160, a PCS transceiver 170, a GPS receiver, and duplexers 191, 192 allowing signals to be transmitted and received via the same antenna. The CDMA transceiver 160 and the PCS transceiver 170, which constitute an RF transceiver for transmitting and receiving RF signals, are connected to a wideband antenna 200a through a diplexer 210a. The GPS receiver 180 receives GPS information via a GPS antenna 200b which is provided separately from the wideband antenna 200a, independently of the RF transceiver for voice and data communications.

However, there has been a problem in that since the GPS antenna incorporated in the conventional mobile communication terminal is mainly a chip-type antenna or an inner antenna (intenna) which is built in the mobile communication terminal, it is inferior in antenna performance compared to an external antenna such as a whip-type antenna, a helical-type antenna, or a dual-type antenna which is a combination of the whip-type and helical-type antennas.

### SUMMARY OF THE INVENTION

The present invention provides a mobile communication terminal supporting S-GPS (simultaneous global positioning system) capable of receiving GPS information via a built-in antenna during communication and via an external antenna during non-communication.

According to an aspect of the present invention, there is provided a mobile communication terminal supporting S-GPS which has a controller, a keypad, a display unit, an audio processor, a memory unit, and an RF (radio frequency) transceiver, the mobile communication terminal including: a wideband antenna receiving a CDMA-band signal, a PCS-band signal, and a GPS-band signal; a GPS antenna receiving only a GPS-band signal; and a switching unit switching to connect the wideband antenna or the GPS antenna to a GPS receiver according to a control signal so that a GPS signal can be received via the wideband antenna or the GPS antenna.

The switching unit may switch to connect the wideband antenna to the GPS receiver upon receiving through the RF transceiver a control signal indicating that a signal is not being transmitted, and the switching unit may switch to connect the GPS antenna to the GPS receiver upon receiving through the RF transceiver a control signal indicating that a signal is being transmitted.

The mobile communication terminal may further include a triplexer which allows a CDMA signal and a PCS signal to be transmitted and received and allows a GPS signal to be received via the wideband antenna.

The switching unit may be an SPDT (Single Pole Double Throw) switch which switches so that a single input signal can be output to any one of two outputs according to a control signal.

The wideband antenna may be an external antenna of whip type, helical type, or dual type which is a combination of the whip type and the helical type.

The GPS antenna may be a built-in antenna of chip type or intenna type.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional mobile communication terminal supporting S-GPS; and

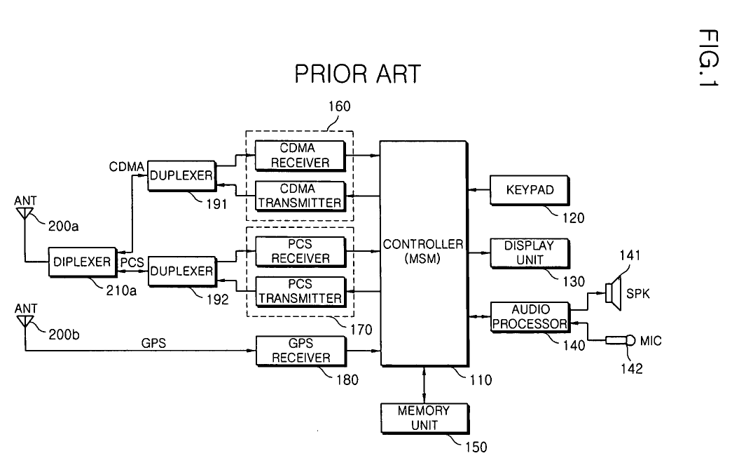

FIG. 2 is a block diagram of a mobile communication terminal supporting S-GPS in accordance with an embodiment of the present invention.

### DETAILED DESCRIPTION OF THE INVENTION

Exemplary embodiments in accordance with the present invention will now be described in detail with reference to the accompanying drawings.

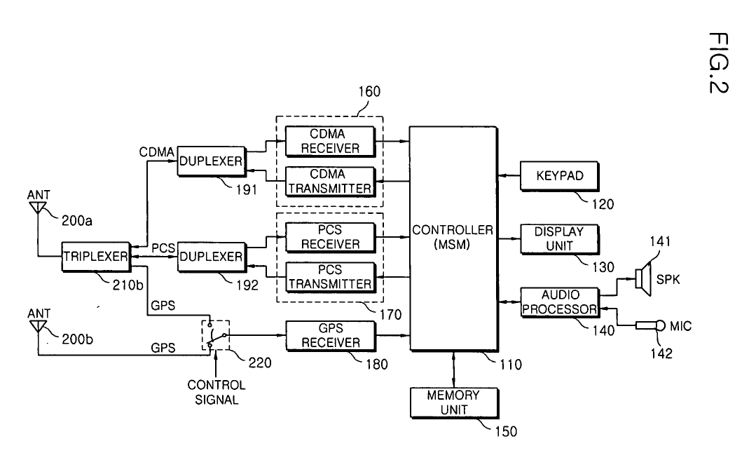

FIG. 2 is a block diagram of a mobile communication terminal supporting simultaneous-GPS (S-GPS) in accordance with an embodiment of the present invention. In the present embodiment, the present invention is applied to a triple-band type mobile communication terminal supporting CDMA/PCS/GPS functions.

The mobile communication terminal typically includes a controller 110, a keypad 120, a display unit 130, an audio processor 140, a memory unit 150, and an RF transceiver 160, 170. The mobile communication terminal further includes a wideband antenna 200a, a GPS antenna 200b, and a switching unit 220.

The controller 110 is responsible for controlling the mobile communication terminal. Qualcomm's MSM (Mobile Station Modem) chipset is typically employed as the controller 110.

The display unit 130 allows a user to monitor the operation of the mobile communication terminal.

The audio processor 140 is an audio codec processing audio signals inputted or outputted through a microphone 142 or a speaker 141.

The memory unit 150 storing data is typically a flash memory.

The RF transceiver communicates with base stations to transmit and receive RF signals. A triple-band type RF transceiver includes the CDMA transceiver 160 and the PCS transceiver 170, while a dual-band type RF transceiver includes either the CDMA transceiver 160 or the PCS transceiver 170.

Duplexers 191, 192 allow signals to be transmitted and received via the same antenna.

The mobile communication terminal according to the present invention receives GPS information via a built-in antenna during communication, and via an external antenna during non-communication. In general, the external antenna is superior in antenna performance to the built-in antenna. The mobile communication terminal according to the present invention further includes a wideband antenna 200a, a GPS antenna 200b, and a switching unit 220.

The wideband antenna 200a is configured to receive CDMA-band signal, PCS-band signal, and GPS-band signal. The wideband antenna 200a is preferably an external antenna of whip-type, helical-type, or dual-type which is a combination of both of them.

The GPS antenna 200b is configured to receive only GPS-band signal, and is preferably a built-in antenna of chip-type, or an intenna.

The switching unit 220 switches to connect the wideband antenna 200a or the GPS antenna 200b to the GPS receiver 180 according to a control signal so that the GPS signal can be received via the wideband antenna 200a or the GPS antenna 200b.

When the switching unit 220 receives through the RF transceiver a control signal indicating that signals are not being transmitted, the switching unit 220 switches to connect the wideband antenna 200a to the GPS receiver 180. Meanwhile, when the switching unit 220 receives through the RF transceiver a control signal indicating that signals are being transmitted, the switching unit 220 switches to connect the GPS antenna 200a to the GPS receiver 180. Accordingly, the mobile communication terminal receives GPS information via the GPS antenna 200b during communication and receives GPS information via the wideband antenna 200a during non-communication, thereby improving GPS performance.

For example, a ‘TX_ON signal’ can be used as the control signal. In more detail, when voice or data communication is made through the RF transceiver of the mobile communication terminal, a ‘TX_ON signal’, which is used as the control signal, is set to a high level and is applied by the controller 110. Meanwhile, when voice or data communication is not made through the RF transceiver of the mobile communication terminal, the ‘TX_ON signal’ is set to a low level and is applied by the controller 110.

That is, when a value of the ‘TX_ON signal’ is ‘1’ (high level) , the switching unit 220 switches to connect the GPS antenna 200b to the GPS receiver 180. Meanwhile, when a value of the ‘TX_ON signal’ is ‘0’ (low level), the switching unit 220 switches to connect the wideband antenna 200a to the GPS receiver 180.

A Single Pole Double Throw (SPDT) switch may be used as the switching unit 220. The SPDT switch switches so that a single input signal can be output to any one of two outputs according to a control signal.

In accordance with another embodiment of the present invention, the mobile communication terminal supporting S-GPS may further include a triplexer 210b.

The triplexer 210b allows CDMA signal and PCS signal to be transmitted and received, and allows GPS signal to be received via the wideband antenna 200a.

That is, the triplexer 210b is employed so that the present invention can be applied to a triple-band type mobile communication terminal supporting CDMA/PCS/GPS functions via the wideband antenna 200a. Accordingly, CDMA/PCS/GPS signals received via the wideband antenna 210b are respectively sent to the CDMA transceiver 160, the PCS transceiver 170, and the GPS receiver 180 through the triplexer 210b so that the present invention can be applied to the triple-band type mobile communication terminal.

As apparent from the above description, a mobile communication terminal supporting S-GPS according to the present invention receives GPS information via a built-in antenna during communication and receives GPS information via an external antenna during non-communication, thereby improving S-GPS performance.

While the present invention has been described with reference to exemplary embodiments thereof, it will be understood by those skilled in the art that various changes in form and details may be made therein without departing from the scope of the present invention as defined by the following claims.

What is claimed is:

1. A mobile communication terminal supporting S-GPS (Simultaneous Global Positioning System) which includes a controller, a keypad, a display unit, an audio processor, a memory unit, and an RF (radio frequency) transceiver, the mobile communication terminal comprising:
a wideband antenna receiving a CDMA (Code Division Multiple Access)-band signal, a PCS (Personal Communication Services)-band signal, and a GPS-band signal;
a GPS antenna receiving only a GPS-band signal; and
a switching unit switching to connect the wideband antenna or the GPS antenna to a GPS receiver according to a control signal so that a GPS signal can be received via the wideband antenna or the GPS antenna.

2. The mobile communication terminal of claim 1, wherein the switching unit switches to connect the wideband antenna to the GPS receiver upon receiving through the RF transceiver a control signal indicating that a signal is not being transmitted, and the switching unit switches to connect the GPS antenna to the GPS receiver upon receiving through the RF transceiver a control signal indicating that a signal is being transmitted.

3. The mobile communication terminal of claim 1, further comprising a triplexer which allows a CDMA signal and a PCS signal to be transmitted and received and allows a GPS signal to be received via the wideband antenna.

4. The mobile communication terminal of claim 2, further comprising a triplexer which allows a CDMA signal and a PCS signal to be transmitted and received and allows a GPS signal to be received via the wideband antenna.

5. The mobile communication terminal of claim 1, wherein the switching unit is an SPDT (Single Pole Double Throw) switch which switches so that a single input signal can be output to any one of two outputs according to a control signal.

6. The mobile communication terminal of claim 2, wherein the switching unit is an SPDT (Single Pole Double Throw) switch which switches so that a single input signal can be output to any one of two outputs according to a control signal.

7. The mobile communication terminal of claim 1, wherein the wideband antenna is an external antenna of whip type, helical type, or dual type which is a combination of the whip type and the helical type.

8. The mobile communication terminal of claim 2, wherein the wideband antenna is an external antenna of whip type, helical type, or dual type which is a combination of the whip type and the helical type.

9. The mobile communication terminal of claim 1, wherein the GPS antenna is a built-in antenna of chip type or intenna type.

10. The mobile communication terminal of claim 2, wherein the GPS antenna is a built-in antenna of chip type or intenna type.
